(19) United States
(12) Patent Application Publication
(10) Pub. No.: US 2009/0000391 A1
(43) Pub. Date: Jan. 1, 2009

(54) Method and Device for Measuring a Escaping Liquid

(75) Inventors: Roland Dorrmann, Rodermark (DE); Eric Folz, Biblis (DE)

Correspondence Address: WRB-IP LLP, 1217 KING STREET, ALEXANDRIA, VA, 22314, US

(73) Assignee: REA ELEKTRONIK GMBH, 64367 Waschenbach (DE)

(21) Appl. No.: 11/817,886

(22) PCT Filed: Mar. 6, 2006
(86) PCT No.: PCT/EP06/02032

§ 371 Date: Jul. 17, 2008

(30) Foreign Application Priority Data
Mar. 7, 2005 (DE) 10 2005 010 847.4

(51) Int. Cl. G01F 1/66

(52) U.S. Cl. 73/861.18; 356/436

(57) ABSTRACT

A method for measuring liquid discharging through an outlet opening includes transmitting and directing a measuring signal so that the discharging liquid crosses it and receiving and analyzing the measuring signal by a receiver, wherein the measuring signal has a measuring signal beam width that is greater than the outlet opening of the discharging liquid. A measuring device is also disclosed.

The invention relates to a method for measuring liquid discharging through an outlet opening wherein a measuring signal is transmitted and directed so that the discharging liquid crosses through said measuring signal and then said measuring signal is received and analyzed by a receiver. It is irrelevant whether the liquid has low or high viscosity or whether the liquid is in the form of individual, separated drops or a continuous stream.

A large number of applications are known in practice in which liquid or pasty materials can be discharged via a nozzle. Such materials are, for example, paints, glue, solvents or cleaning agents that are applied with nozzles and often are automatically processed. To be able to determine during the application, if necessary, that material is in fact discharged or that sufficient amounts of material are discharged, measuring processes and devices are known that prove that the material is in fact discharged (for example DE 198 42 266 B4 or DE 195 43 869 A1).

Precise quantity control for fluid materials discharging from nozzles, for example in the chemical or food processing industries, is desirable or required. DE 197 41 824 A1 describes a device that uses optical measurements to measure the quantity of a discharging spray mist. Since the measuring device used detects and analyzes the scattered light reflected by the spray mist, such a method cannot simply be applied, with a comparable degree of accuracy, to the process of determining the quantity of individual drops or a fine spray mist.

For some applications it might be practical to be able to not only show that material does in fact discharge, but also to be able to measure information concerning the shape of the discharging spray stream. To this end it is known (DE 197 27484 C2 or DE 198 28 592 A1) to detect a plurality of luminous beams of photo detectors arranged at a distance from one another that shine through the spray stream and to analyze the measured light quantities so that a divergence of the spray stream or a deviation from a given divergence of the spray stream can be determined. This type of measuring device as mentioned in the beginning allows for quick detection if the beam geometry changes.

For example, in the area of manufacturing electronic switches and components it has become customary to discharge small and tiny quantities of liquid or pasty materials from controllable nozzles.

Thus, electronic switches can be automatically equipped with the individual electronic components and said components then can be fastened and soldered to the respective printed board The required solder is discharged from the small nozzle that is mobile relative to the surface of the printed board and can be controlled so that it is possible to obtain a directed application of the solder in a certain point.

If, for some reason, no or not enough solder discharges from the nozzle, the respective solder point is not produced reliably so that the respective electronic component does not function at all or only functions poorly. With an increasing number of soldering joints as well as increasing complexity of the respective electronic component, a manual or even automated inspection of the finished electronic components prior to shipping becomes increasingly labor-intensive and expensive. Especially in the case of electronic components that either is used in expensive or safety/security sensitive devices, it often is necessary that the electronic components contained in such devices work flawlessly and reliably or can be manufactured with low rejection rates.

Apart from providing proof that material or solder, respectively, does in fact discharge from the nozzle and after determining the discharging amount of solder, it would be desirable to have a control mechanism for the discharge speed of the solder. This mechanism would ensure that discharging solder drops do not burst due to excessive discharge speed or that solder does not splatter or is deposited in an undesirable spot.

It also is possible that the discharging material contaminates the measuring device and impedes its accuracy. The possibility of contamination increases considerably with decreasing distance between the individual measuring device elements and the discharging spray stream. Most known measuring devices therefore are arranged at a sufficient distance from the discharging liquid. However, also known are applications, such as the above described discharge of solder, for example, in which a large distance between the measuring device and the outlet nozzle is not practical or possible. It is known (EP 222 258 A2) to arrange a signal transmitter and a signal receiver on the side next to the outlet opening in a manner as to ensure that the signal emitted by the transmitter hits the receiver and to protect the transmitter and receiver pneumatically against contamination due to a precipitation of discharging liquid on the transmitter or receiver, by directing an air stream in the direction of the discharging liquid.

It is desirable to provide a method for measuring a liquid that is discharged from an outlet opening that ensures that the discharging liquid and, if necessary, additional properties of the discharging liquid can reliably be measured and analyzed. If necessary, the method is to provide continuous monitoring of the liquid that is discharged from the outlet opening.

According to an aspect of the invention the measuring signal has a measuring signal beam width that is greater than the outlet opening of the discharging liquid. The measuring signal preferably can be in the form of a light beam or a laser beam. Using suitable optical components, a light beam can be directed so that the light beam runs diagonally directly in front of the outlet opening of the discharging liquid. Laser diodes or photo diodes provide miniturizable transmitters or receivers of a measuring signal that provide highly precise measurements while requiring little space. Also suitable for producing a measuring signal are light diodes or other light sources that can generate sufficient light intensity in a detectable wavelength range.

Instead of light it also is possible to use sound as a suitable measuring signal. Suitable, if necessary high-frequency, sound sources and sound receivers are commercially available and inexpensive and can be used advantageously based on the given requirements. Furthermore, any measuring signal is suitable that can be transmitted and detected across a sufficient distance without electric components.

When the discharging liquid crosses the light beam of a visible or non-visible wavelength range, the light beam is at least partially overshadowed or deflected or its intensity is weakened and only a share that is reduced in relation to the undisturbed light beam is received by the receiver. The reduction of the received light beam can be analyzed as proof and as a measuring signal for the discharge of the liquid.

Since the measuring signal beam width is greater than the outlet opening for the liquid a smaller distance between the measuring signals directed diagonally to the outlet opening and the outlet opening itself ensures that each discharging drop of liquid is detected. Even if only an often inevitable small satellite drop is discharged or if drops of liquid or the beam discharge in a crooked or uncontrolled manner due to a defect, the beam width of the measuring signal ensures that even in these cases the discharging liquid is caught and detected.

In an advantageous manner the measuring signal beam width is a multiple of the opening width of the outlet opening. This means the distance between the measuring signal and the outlet opening is no longer of significant importance and can easily be adapted to the device.

In order to be able to provide a reliable statement concerning a discharging liquid drop, a definable reduction of the measuring signal received in the receiver is used as proof that liquid discharged. Since the measuring signal beam width in principle is wider than the discharging liquid drop or the liquid stream, respectively, the discharging liquid does not completely cover the measuring signal beam. Depending on the measuring signal beam width and the defined drop size or size of the outlet opening, respectively, a reduction of the measuring signal by at least 10% can be assigned to a discharging liquid drop while a smaller reduction of the measuring signal is interpreted as proof for satellite drops or such.

According to one embodiment of the inventive thought an upper and a lower threshold are set and a reduction of the measuring signal received by the receiver within the range defined by the thresholds is used as proof that liquid is discharged. For example, thresholds can be set for a relative reduction of the measuring signal between 10% and 40% and a reduction in the defined range can be interpreted as a properly discharging liquid drop.

In order to recognize a malfunction during the execution of the process, an upper and a lower threshold can be defined and a reduction of the measuring signal in the receiver to a value outside the range defined by the thresholds is proof of an inadvertent discharge of liquid.

Preferably, the receiver transmits a receiver signal in relation to the detected reduction of the measuring signal received in the receiver that is proportional to the reduction. Receivers are known and suitable for use in the described method that detect a relative reduction of 1% reliably and precisely and can convert it to receiving signals. A proportional receiving signal can serve as a basis for further analysis of the measuring signal.

It also is feasible to establish a self-regulating system in relation to the measured reduction of the received measuring signal and to monitor or influence the liquid discharge.

If the liquid usually discharges in the form of individual drops from the opening, this method can be used to easily determine the number of the discharging drops. If the volume of the individual droplets is known, it is possible to determine the approximate total volume of several individual drops that discharge in droplet form. By measuring the starting time and the ending time of the liquid discharge, it is possible to determine its discharge speed if the shape of the drops is known.

It also is possible, based on a given known discharge speed of a continuous liquid stream from the opening, to determine the discharging liquid volume by measuring the starting time and the ending time of the liquid discharge. Thus, the described method provides an easy way to monitor the discharging liquid and to determine individual parameters.

If such a method according to the invention is used in connection with an automated application of solder for fastening and connecting electronic components on a printed board, it is possible to monitor the amount of solder used for each individual solder joint. It is easily possible to use a suitable analysis to control or regulate the solder discharging from a nozzle in the manufacture of electronic components. This way it is possible to provide reliable monitoring already during the manufacturing process for the individual solder joints. The efforts for a manual or automatic function control of the completed electronic component following manufacture thus can be reduced considerably.

Preferably, two measuring signals are arranged at a distance from another in such a way that both measuring signals are crossed by said liquid IN succession and subsequently are received by their respective receiver. The time difference between the entry and exit, respectively, of the liquid relative to the two measuring signals can be used with non-continuous liquid discharge to measure and control the liquid discharging from the opening.

An orientation of the measuring signals that are arranged at a distance from one another in two different directions relative to each other can be advantageous in regard to constructive design possibilities as well as for the analysis of the measuring signals. Due to the opposite orientation of the measuring signals relative to one another, it is possible to avoid undesirable influence due to inductive disturbance of the two measuring signals.

Advantageously, the volume of the discharging liquid can be determined by assuming a definable geometry of the discharging liquid. The determination of the volume of the discharging liquid can be improved with a crosswise arrangement and arrangement at a distance of the two measuring signals by assuming an approximate description of the shape of the discharging liquid and whose volume is determined based on the analysis of the relative reduction of the respective received measuring signals and a preceding determination of the air time of the drop. The shape of the drop or stream of the discharging liquid, however, can reliably be defined if the pressure conditions are known and the outlet nozzle is designed accordingly. In doing so, the speed of the discharging liquid can also be calculated reliably.

According to an embodiment of the inventive thought at least two measuring signal arrangements comprised of at least two measuring signals arranged parallel to each other are arranged at a distance form one another in two different directions so that the measuring signal arrangements are crossed by the liquid in succession and each measuring signal is received by the receiver with a first separate analysis of the individual measuring signals and subsequent determination of a flight path for the discharging liquid being done. This way it is not only possible to detect and determine the discharge of individual drops or a liquid stream or the discharging volume of the liquid, but it is also possible to estimate the flight path of the discharging liquid.

This means that the automated application of solder can be controlled and monitored not only with regard to a minimum required amount of solder but also with regard to the application location of the solder without any additional optical inspection. The most frequent causes of defective solder joints, i.e. missing or insufficiently applied solder or solder applied to the wrong location, can reliably be detected and, if necessary, avoided, or corrected, respectively.

In particular in the case of complex electronic components it is practical and advantageous if, by using the described method, the manufacturing process is not only monitored but can also be controlled or regulated, respectively. The resulting avoidance of faultily manufactured electronic components or the reduced expense and higher degree of reliability of a subsequently carried out functional check are associated with cost savings, which considerably exceed the expenses associated with the application of the measuring method.

The invention also concerns a measuring device for liquids discharged from an outlet opening, in particular for carrying out the above described method. Known are two measuring devices (DE 198 42 266 B4), that comprise a measuring signal transmitting transmitter and a measuring signal receiving receiver that are arranged relative to one another so that the discharging liquid crosses the measuring signal and thus causes a change to the measuring signal that is received in the receiver and that can be analyzed in an analysis unit. Such measuring devices with separately arranged and fastened transmitters and receivers for the measuring signal, however, require additional space in the outlet area of the liquid on the side in front of the outlet opening.

Also known are measuring devices (EP 222 258 A2) that have caps that protrude on the side of the outlet opening, in which a transmitter and a receiver for the measuring signal are arranged on opposing sides and relative to one another. Although the additional space requirement for such measuring devices is smaller than for measuring devices with separately arranged transmitter and receiver devices, a minimum distance between the outlet opening of the liquid and the designated application location of the liquid is required to allow for sufficient space for the transmitter and receiver units arranged on opposite sides.

It is desirable, therefore, to design a measuring device such that discharging liquids can be detected reliably, and at the same time, only small additional space is required for the transmitter and receiving devices. In doing so it would be advantageous if only a small distance between the outlet opening and the designated application area of the liquid.

According to an aspect of the invention the transmitter and receiver are arranged on the side next to the outlet opening in a way so that the measuring signal is emitted and detected substantially parallel to the discharging liquid and so that the measuring signal is deflected by means of optical components so that said measuring signal runs diagonal in front of the outlet opening.

Preferably the measuring signal is a light beam or a laser beam wherein the measuring signal can be directed and focused using optical components such as lenses, mirrors, deflector prisms or diaphragms.

Transmitter and receiver can be arranged in a space-saving manner, for example, in form of a laser diode or a photo diode, respectively, in the area next to the outlet opening of the discharging liquid. By using suitable signal guide components, such as lenses, prisms or diaphragms, the light beam or laser beam that is used as a measuring signal can be deflected in almost any direction and the cross-section can be defined. The transmitter and the receiver therefore must not be arranged opposite of one another and aligned relative to one another but instead can be arranged on the side or at a distance to the outlet opening of the discharging liquid. Thus it is possible to precisely monitor the outlet opening of the discharging liquid even in tight spatial conditions and the discharging liquid can be detected by the measuring signal.

If there is only to be proof of discharging liquid, there are no special requirements to the beam geometry or the beam direction of the measuring signal. If, however, the receiver allows the measuring of a relatively small change of the received measuring signal with an appropriate degree of accuracy and thus allows, for example, the determination of additional parameters of the discharging liquid, a precise beam direction and a defined beam cross-section of the measuring signal are advantageous. This can easily be achieved by arranging one or a plurality of slit diaphragms in the beam path of the measuring signal.

With the help of the slit diaphragm, a flat, wide beam profile of the measuring signal can be defined. It is practical to arrange a slit diaphragm following the transmitter as well as in front of the receiver in order to reduce the influence of scattered light from the sides.

Advantageously the discharging liquid crosses the measuring signal directly in the surroundings of the outlet opening. For example, a light beam or laser beam coming from the side can be deflected by prisms or mirrors arranged on the sides of the outlet opening so that said beam runs diagonally at a very small distance from the outlet opening. As soon as the required liquid quantity discharges, it must cross the light beam so that the discharge of the liquid is reliably detected.

According to one embodiment of the inventive thought two measuring signals are transmitted from at least one transmitter, said measuring signals being arranged at a distance from one another in different directions so that the liquid crosses both measuring signals in succession and so that the two measuring signals are received by one receiver each. In such an arrangement the discharging liquid crosses the two measuring signals that run in different directions in succession so that, for example, it is possible to detect the speed or the volume of the discharging liquid based on the assumption of approximately known parameters, if necessary.

According to an advantageous embodiment of the inventive thought the measuring device comprises at least two measuring signal arrangements that are arranged at a distance from one another in different directions so that the liquid crosses both measuring signal arrangements in succession whereby at least two measuring signals arranged in parallel are transmitted by at least one transmitter for each measuring signal arrangement and wherein each measuring signal is received by its respective receiver. Based on these at least two, or, as required, a plurality of measuring signals, for example laser beams, run side by side, additional information concerning the flight path of the discharging liquid can be determined with this embodiment and arrangement of the measuring device. In the most simple case an approximate flight direction of the discharging liquid can be determined based on a comparison of the relative signal change of individual measuring signals between two or a plurality of measuring signal arrangements arranged in series

### BRIEF DESCRIPTION OF THE DRAWINGS

The following paragraphs describe the exemplary embodiments of the inventive thought shown in the drawing in more detail. The following is shown:

FIG. 1 shows a sectional view of a measuring device comprising a transmitter and a receiver as well as a plurality of optical components for directing the beam of a measuring signal.

FIG. 2 shows a side view of the measuring device shown in FIG. 1.

FIG. 3 shows a top view of the measuring device.

FIG. 4 shows a different side view of the measuring device.

FIG. 5 shows an angular view of the measuring device.

FIG. 6 shows a schematic side view of a beam direction of the measuring signal between a transmitter and a receiver as realized in the measuring device according to FIG. 1-5.

FIG. 7 shows a schematic top view of the beam direction shown in FIG. 6.

FIG. 8 shows a schematic side view of a beam direction with two crossed measuring signal beams arranged at a distance from one another, each comprising a transmitter and a receiver.

FIG. 9 shows a schematic top view of the beam direction shown in FIG. 8.

FIG. 10 and FIG. 11 show a schematic side view of a beam direction according to FIGS. 8 and 9 wherein, however, two measuring signals each arranged in parallel, form one measuring signal arrangement, and two measuring signal arrangements are arranged at a distance from one another with crossed beam directions and;

FIG. 12 through FIG. 15 show views comparable to the views in FIG. 2 through 5 of a measuring device in which two measuring signal beams run at a distance from one another and diagonal to the outlet opening.

### DETAILED DESCRIPTION

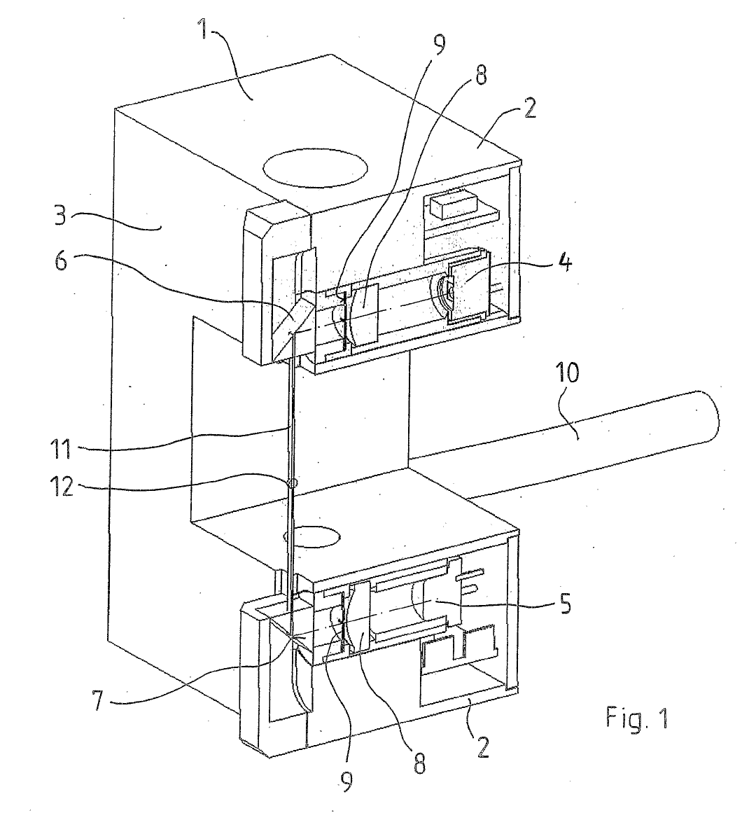

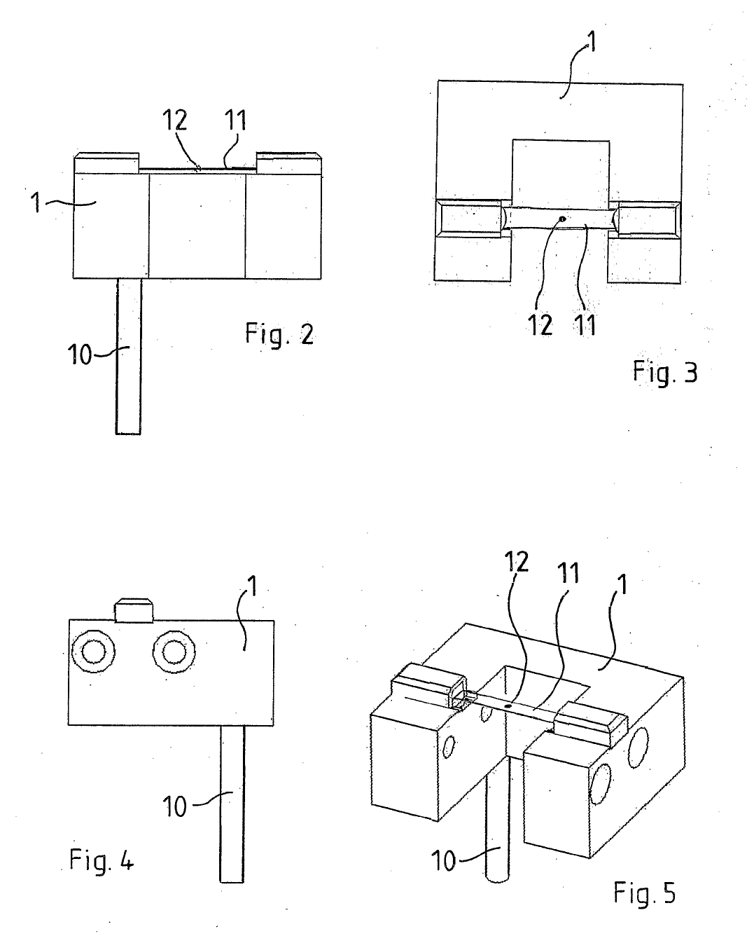

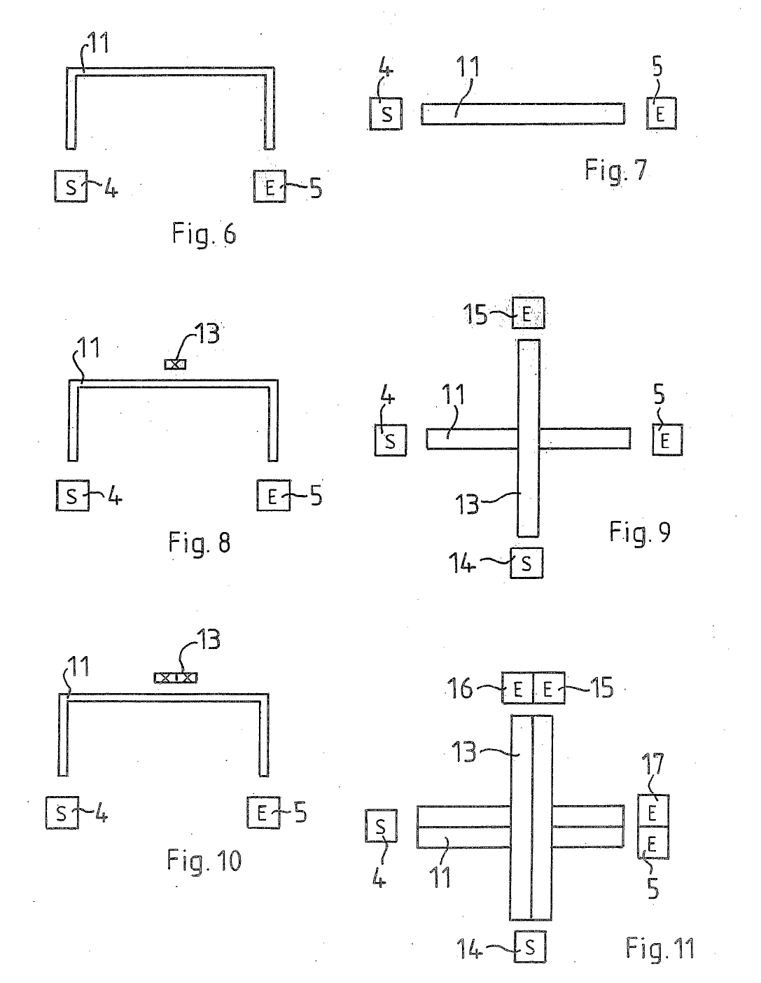

FIGS. 1 through 5 show an exemplary embodiment of a measuring device for carrying out the method that is suitable for continuous monitoring of a flow agent that discharges from a nozzle that is not shown. The measuring device that comprises a substantially C-shaped housing 1 with two lateral caps 2 arranged at a distance from one another. The dimensions of the housing 1 and especially the distance of the lateral caps 2 practically is such that the housing 1 is arranged and fastened to an outlet nozzle for liquids that is not shown so that an upper side 3 of the housing 1 substantially is flush with an outlet opening, which also is not shown, of the outlet nozzle.

On one side of the lateral caps 2 a transmitter 4 and on the other side a receiver 5 is arranged. The transmitter 4 is a laser diode whose laser beam initially is emitted substantially parallel to the direction of the discharging liquid. The laser beam is deflected by a first deflector prism 6 so that the laser beam is directed at a small distance above the upper side 3 of the housing 1 diagonal to the outlet opening and on the other side of the outlet opening is directed to the receiver 5, a photo diode, by a second deflector prism 7. If necessary, it is possible to arrange additional filters, such as interference filters, in the path of the laser beam from the transmitter 4 to the receiver 5. Since only the two deflector prisms 6 and 7 necessarily must extend over the upper side 3 of the housing 1 and thus over the outlet opening, the other components, such as the transmitter 4 and the receiver 5, can be arranged next to the outlet nozzle or at a distance from the outlet opening.

It is possible to manufacture an extremely compact and versatile measuring device in this manner.

The laser beam emitted from the transmitter 4 is focused by the lenses 8 on the way to the receiver 5 and its cross-section is defined by slit diaphragms. Especially due to the slit diaphragms 9 it is possible to define a well-defined and precise beam geometry of the measuring signal in the area of the outlet opening. The measuring signal beam width is larger than the outlet opening for liquid so that discharging liquid drops or a discharging liquid beam cross through the measuring signal within its entirety and cause a partial overshadowing of the measuring signal.

This way a quantitative analysis of the overshadowing caused by the discharging liquid that crosses the laser beam can be carried out with a high degree of accuracy. The defined beam direction and beam geometry furthermore are of great significance for determining the volume of the discharging liquid as well as its flight path.

In the housing 1 of the measuring device all electronic components are arranged that are required for the generation and the measuring of the laser beam as well as the analysis of the received measuring signals. Via a connecting cable 10 the measuring device is supplied with energy on one hand, and on the other hand it allows the transfer of the received measuring signals or the analyzed measuring variable and information to an external control unit. It is practical that the receiver 5 measures the resulting voltage difference with a partial overshadowing of a photo diode and generates an output signal that is proportional to the measured voltage difference or to the overshadowing of the measuring signal, respectively. Commercially available receivers 5 can be used to reliably detect relative overshadowing of the measuring signal of approximately 1%.

Alternatively, the components required for the generation and analysis of the measuring signal can be arranged externally and can be connected to the measuring device via suitable signal connections and interfaces.

FIG. 2-5 show different perspectives of the measuring device shown in detail in FIG. 1. For illustration purposes FIG. 1-5 schematically show a laser beam 11 between the two deflector prisms 6, 7. For illustration purposes, furthermore a liquid drop 12 discharging from an outlet opening that is not shown is shown as it crosses the laser beam 11.

FIG. 6-11 show schematic views of several different embodiments of a measuring device. FIGS. 6 and 7 show schematic views of the course of the beam of the laser beam 11 between the transmitter 4 and the receiver 5 as it is realized in the device shown in FIG. 1 through 5. Deviating from this FIGS. 8 and 9 show a side view or a top view, respectively, of a measuring device in which additionally another laser beam 13 is emitted from a transmitter 14 and is received by a receiver 15 with the laser beam 13 being directed so that it runs diagonal and at a distance to the first laser beam 11, also in the area of the outlet opening that is not shown. By analyzing the received measuring signals, for example by the time difference of the successive turning off of the laser beams 11 and 13 by the discharging liquid, it is possible to determine their respective speed, for example.

In the side and top views of the schematic arrangements shown in FIGS. 10 and 11, the laser beam 11, 13 generated by the transmitters 4, 14 is separated into two parallel partial beams by suitable optical components. Each partial beam is received and analyzed by its respective receiver 5, 15, 16, 17. Such an arrangement makes it possible to obtain additional information about the flight path of the discharging liquid. It also is possible to use a transmitter for each measuring signal instead of using a mutual transmitter 4, 14 and subsequent separation of the measuring signal.

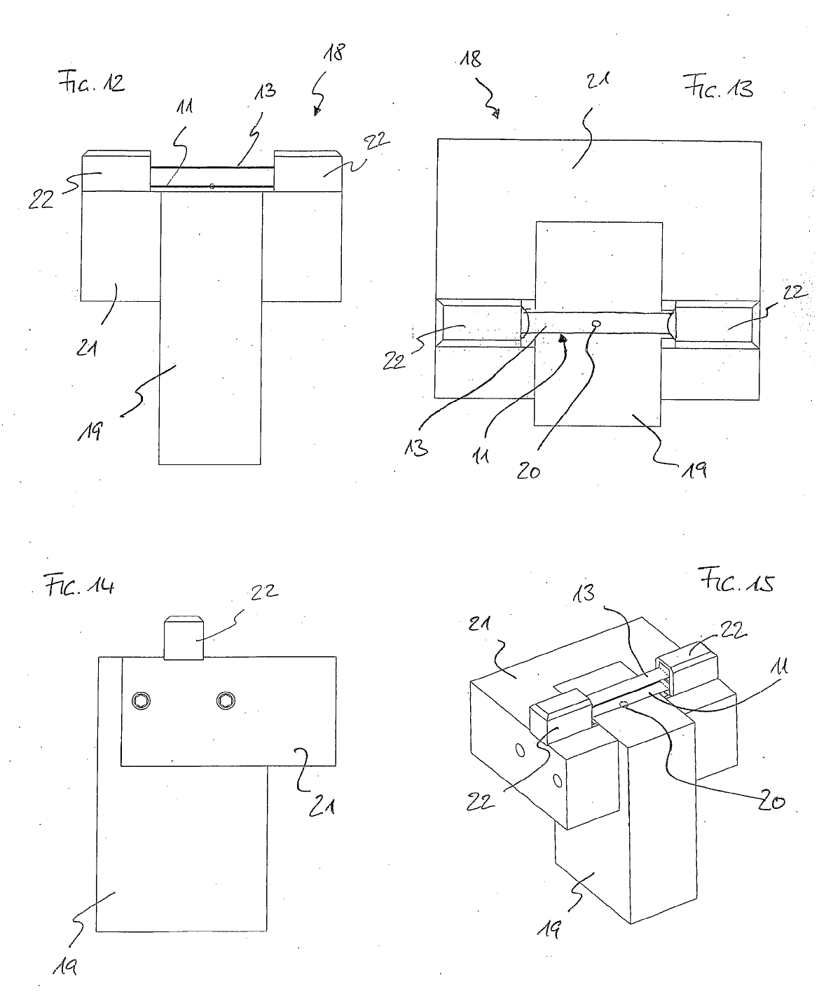

FIG. 12 through 15 show an additional exemplary embodiment of a different measuring device 18. The views shown in FIG. 12 through 15 correspond to the views shown in FIG. 2 through 5. In addition, for illustration purposes, a spray head 19 with an outlet opening 20 [sic/end of sentence] In this differently arranged measuring device 18 not one, but two laser beams 11 and 13 run diagonal in front of the outlet opening 20 at a distance from one another. This embodiment thus schematically corresponds to the measuring method shown in FIGS. 8 and 9. The external dimensions of a housing 21 of the measuring device 18 substantially correspond to those of housing 1 of the measuring device shown in FIG. 1 through 5. Not shown in housing 21 are, transmitter and receiver, for each laser 11, 13, separately, as well as the required optical components [sic]. The deflection of the laser beams 11, 13 generated next to the spray head 19 is accomplished with two deflector prisms, with each being arranged in small elevations 22 next to the outlet opening 20.

Instead of using laser beams or generally light beams for measuring the discharging liquid, it also is possible to use sound waves with suitable frequencies. Instead of the different optical components, a sound source, a suitable microphone as well as substantially mechanical sound direction components, is used.

The exemplary embodiments shown all show a transmitter that generates a plurality of parallel partial beams of the measuring signal, if required. It also is possible and practical for some applications to use a respective transmitter and a respective receiver for each partial beam of the measuring signal used.

The measuring device can be modified with simple means so that a plurality of nozzles or outlet openings for discharging liquids can be monitored simultaneously and the discharging liquids can be measured.

1-22. (canceled)

23. Method for measuring liquid discharging through an outlet opening comprising transmitting and directing a measuring signal so that the discharging liquid crosses it and receiving and analyzing the measuring signal by a receiver, wherein the measuring signal has a measuring signal beam width that is greater than the outlet opening of the discharging liquid.

24. Method according to claim 23 wherein the measuring signal beam width is a multiple of the opening width of the outlet opening.

25. Method according to claim 23 wherein a definable reduction of the measuring signal received in the receiver is proof that liquid is discharged.

26. Method according to claim 25 wherein an upper and a lower threshold are defined and a reduction of the measuring signal received in the receiver within the range defined by the thresholds is proof that liquid is discharged.

27. Method according to claim 25 wherein an upper an a lower threshold are defined and a reduction of the measuring signal received in the receiver to a value outside of the range defined by the thresholds is proof of an unintended discharge of liquid.

28. Method according to claim 23 wherein the receiver, based on the detected reduction of the measuring signal received in the receiver emits a receiver signal that is proportional to the reduction.

29. Method according to claim 23 wherein two measuring signals are directed at a distance from one another in two different directions so that the liquid crosses both measuring signals in succession, the measuring signals then being received by their respective receiver.

30. Method according to claim 29 wherein the two measuring signals are arranged at a distance from one another in two different directions relative to one another.

31. Method according to claim 29 wherein based on the assumption of a given geometry of the discharging liquid the volume of the discharging liquid is determined.

32. Method according to claim 23 wherein at least two measuring signal arrangements each comprised of two measuring signals arranged in parallel, are arranged at a distance from one another so that the liquid crosses the measuring signal arrangements in succession and that each measuring signal is received by a receiver and wherein first a separate analysis of the individual measuring signals and then a determination of a flight path for the discharging liquid occurs.

33. Method according to claim 32 wherein the at least two measuring signal arrangements, each comprised of two parallel measuring signals, are arranged at a distance from one another in different directions relative to one another.

34. Measuring device for liquids discharging from an outlet opening with a transmitter transmitting a measuring signal and a receiver receiving this measuring signal that are arranged relative to one another so that the discharging liquid crosses the measuring signal and thus causes a change of the measuring signal received in the receiver, and with an analysis unit for analyzing the measuring signals wherein the transmitter and the receiver are arranged next to the outlet opening so that the measuring signal is emitted and detected substantially parallel to the direction of the discharging liquid and the measuring signal is deflected by means of optical components so that it runs diagonal in front of the outlet opening.

35. Measuring device according to claim 34 wherein the measuring signal is a sound signal.

36. Measuring device according to claim 34 wherein the measuring signal is a light beam or a laser beam.

37. Measuring device according to claim 36 wherein the measuring signal is directed and focused by means of optical components.

38. Measuring device according to claim 37 wherein the measuring signal is guided through at least one slit diaphragm after exiting the transmitter and prior to entering the receiver.

39. Measuring device according to claim 34 wherein the discharging liquid crosses the measuring signal immediately in the vicinity of the outlet opening.

40. Measuring device according to claim 34 wherein two measuring signals are emitted by at least one transmitter the signals being arranged at a distance from one another so that the discharging liquid crosses both measuring signals in succession and both measuring signals each are received by a receiver.

41. Measuring device according to claim 40 wherein the two measuring signals are directed at a distance from one another in different directions relative to one another.

42. Measuring device according to claim 40 wherein the time difference between the liquid entering or exiting relative to the two measuring signals in a non-continuous discharge of liquid is measurable and the speed of the liquid discharging from the outlet opening can be determined by means of the analysis unit.

43. Measuring device according to claim 34 wherein the measuring device has at least two measuring signal arrangements that are arranged at a distance from one another so that the discharged liquid crosses through both measuring signal arrangements in succession, with at least two parallel measuring signals being emitted for each measuring signal arrangement by a transmitter and with each measuring signal being received by a respective receiver.

44. Measuring device according to claim 43 wherein the measuring device comprises at least two measuring signal arrangements that are arranged at a distance in different directions relative to one another.
